(19) United States
(12) Patent Application Publication
(10) Pub. No.: US 2024/0275931 A1
(43) Pub. Date: Aug. 15, 2024

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: MAI KOMIYAMA, Kanagawa (JP)

(21) Appl. No.: 18/435,716

(22) Filed: Feb. 7, 2024

(30) Foreign Application Priority Data
Feb. 9, 2023 (JP) 2023-018628
Oct. 31, 2023 (JP) 2023-186821

(51) Int. Cl. H04N 13/117; G06T 15/00

(52) U.S. Cl. CPC H04N 13/117; G06T 15/00

(57) ABSTRACT

An information processing apparatus manages a virtual viewpoint designated by a user operation as a virtual viewpoint history, and determines a virtual viewpoint based on the managed virtual viewpoint history. The information processing apparatus sets the virtual viewpoint determined based on the virtual viewpoint history as a virtual viewpoint used to generate a virtual viewpoint image.

### BACKGROUND OF THE DISCLOSURE

### Field of the Disclosure

The present disclosure relates to a technique used to generate a virtual viewpoint image.

### Description of the Related Art

There is a technique for generating an image (hereinafter referred to as a virtual viewpoint image) indicating an appearance from an arbitrary viewpoint (hereinafter referred to as a virtual viewpoint) using a plurality of captured images obtained by performing synchronous image capturing using a plurality of imaging apparatuses installed at different positions. A service using such a virtual viewpoint image makes it possible to provide a user with a content with a realistic viewpoint created based on images captured in, for example, a baseball or soccer game. The service using the virtual viewpoint image enables the user viewing the content to freely select or move the viewpoint (this operation is hereinafter referred to as a virtual viewpoint operation), so that the user viewing the content while operating the virtual viewpoint can obtain a high sense of presence.

Japanese Patent Application Laid-Open No. 2019-28652 discusses a technique in which, in a case where a user is viewing a virtual viewpoint image while performing a virtual viewpoint operation, the virtual viewpoint image is changed to a predetermined virtual viewpoint image if the virtual viewpoint operation from the user is not detected for a predetermined period of time. In the technique discussed in Japanese Patent Application Laid-Open No. 2019-28652, the predetermined virtual viewpoint image is a high-quality virtual viewpoint image created by a sophisticated apparatus, such as a server, and the virtual viewpoint image is created based on a movement path of a predetermined virtual viewpoint.

### SUMMARY OF THE DISCLOSURE

According to an aspect of the present disclosure, an information processing apparatus includes a history management unit configured to manage a virtual viewpoint designated by a user operation as a virtual viewpoint history, a viewpoint determination unit configured to determine a virtual viewpoint based on the virtual viewpoint history managed by the history management unit, and a viewpoint control unit configured to set the virtual viewpoint determined by the viewpoint determination unit as a virtual viewpoint used to generate a virtual viewpoint image.

Further features of the present disclosure will become apparent from the following description of exemplary embodiments with reference to the attached drawings.

### BRIEF DESCRIPTION OF THE DRAWINGS

FIG. 1 is a block diagram schematically illustrating a configuration example of an image generation system according to one or more aspects of the present disclosure.

FIG. 2 illustrates an installation example of a plurality of imaging apparatuses.

FIG. 3 is a block diagram illustrating a hardware configuration example of a display control apparatus according to one or more aspects of the present disclosure.

FIG. 4 is a block diagram illustrating a functional configuration example of the display control apparatus according to one or more aspects of the present disclosure.

FIG. 5 is a table illustrating a virtual viewpoint history held in a history management unit.

FIG. 6 illustrates an example of virtual viewpoint candidates.

FIG. 7 is a flowchart of display control processing according to one or more aspects of the present disclosure.

FIGS. 8A and 8B each illustrate an example of virtual viewpoint determination processing.

FIG. 9 is a block diagram illustrating a functional configuration example of a display control apparatus according to one or more aspects of the present disclosure.

FIG. 10 illustrates an example of image generation information.

FIG. 11 is a flowchart of display control processing according to one or more aspects of the present disclosure.

FIG. 12 is a block diagram illustrating a functional configuration example of a display control apparatus according to one or more aspects of the present disclosure.

FIGS. 13A to 13D2 each illustrate virtual viewpoint determination processing based on a virtual viewpoint history.

### DESCRIPTION OF THE EMBODIMENTS

Exemplary embodiments of the present disclosure will be described below with reference to the drawings. The following exemplary embodiments are not meant to limit the present disclosure. Not all combinations of features described in the exemplary embodiments are essential to the solution of the present disclosure. The configurations of the exemplary embodiments can be appropriately modified or changed depending on the specifications of the apparatus to which the present disclosure is applied and various conditions (e.g., usage conditions, and usage environment).

In the following exemplary embodiments, identical or similar components and processing steps are denoted by the same reference numerals, and redundant descriptions are omitted.

### [System Configuration]

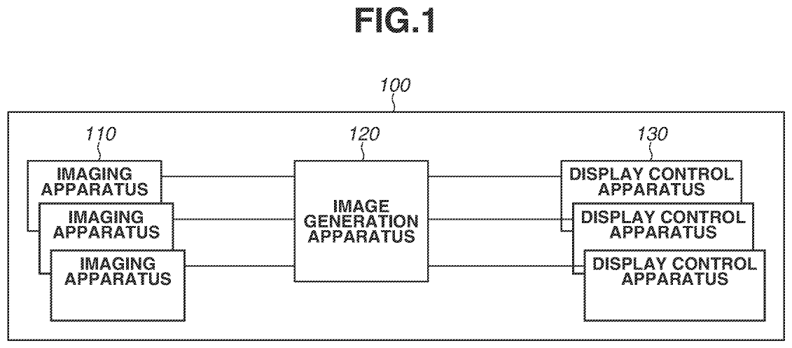

FIG. 1 is a block diagram illustrating a configuration example of an image generation system 100 including an information processing apparatus according to a first exemplary embodiment. As illustrated in FIG. 1, the image generation system 100 includes a plurality of imaging apparatuses 110, an image generation apparatus 120, and one or more display control apparatuses 130. The present exemplary embodiment illustrates an example where each display control apparatus 130 is used as an application example of the information processing apparatus. Alternatively, both the display control apparatus 130 and the image generation apparatus 120 may be included as the information processing apparatus.

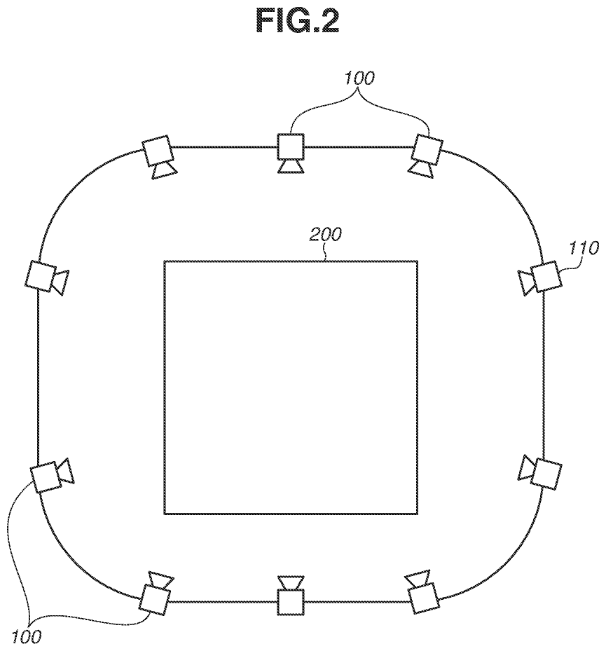

The plurality of imaging apparatuses 110 is each installed at different positions around an imaging area 200 as illustrated in FIG. 2, and the plurality of imaging apparatuses 110 each outputs images of the imaging area 200 that are synchronously captured from different directions. The images captured by the plurality of imaging apparatuses 110 from a plurality of viewpoints are hereinafter referred to as a plurality of viewpoint images. Each imaging apparatus 110 is, for example, a digital camera configured to capture still images and moving images. The plurality of imaging apparatuses 110 may include imaging apparatuses 110 having different functions, such as a telephoto camera and a wide-angle camera.

In the present exemplary embodiment, the imaging area 200 is a baseball field for baseball games. However, the imaging area 200 is not limited to a baseball field, but instead may be a stadium for other sporting events, a stage for performance, or the like.

The plurality of viewpoint images captured by using the plurality of imaging apparatuses 110 is transmitted to the image generation apparatus 120 via a communication medium, such as a local area network (LAN) cable. The plurality of viewpoint images may be wirelessly transmitted to the image generation apparatus 120.

The image generation apparatus 120 is, for example, a server apparatus, and includes a database function and/or an image processing function. The image generation apparatus 120 obtains the plurality of viewpoint images captured by the plurality of imaging apparatuses 110 and stores the obtained viewpoint images. The plurality of viewpoint images may include the images captured by the imaging apparatuses 110, or images obtained by performing image processing, such as processing of extracting a predetermined area, on the captured images. The image generation apparatus 120 generates a virtual viewpoint image indicating an appearance from a viewpoint based on the plurality of viewpoint images and virtual viewpoint information transmitted from the display control apparatus 130 as described below. The virtual viewpoint image is also called a free viewpoint image. The virtual viewpoint image is not limited to an image generated according to a viewpoint freely (arbitrarily) designated by a user. For example, a virtual viewpoint image generated according to a viewpoint selected from among a plurality of viewpoint candidates by the user may also be used.

The image generation apparatus 120 generates the virtual viewpoint image, for example, in the following manner.

The image generation apparatus 120 separates a predetermined foreground object, such as a person, from each captured image included in the plurality of viewpoint images obtained from the plurality of imaging apparatuses 110 as described above, and stores the image of the separated foreground object as foreground image data. As image processing for separating a foreground object from the captured images, for example, processing of extracting a foreground object based on a difference between a captured image and a background image, or processing of separating a moving object detected from a captured image as a foreground object can be used. The image generation apparatus 120 prepares and holds image data obtained by capturing an image of a field of a stadium, a studio set, or the like in a state where objects such as persons are not present, or image data on an imaginary space generated using computer graphics (CG) or the like, in advance as background image data. The image generation apparatus 120 generates a virtual viewpoint image corresponding to each virtual viewpoint included in the virtual viewpoint information transmitted from the plurality of display control apparatuses 130 described below by using the background image data held in advance and the above-described foreground image data.

As a method for generating a virtual viewpoint image, for example, a model-based rendering (MBR) technique can be used. The MBR is a technique for generating a virtual viewpoint image by using a three-dimensional model generated based on a plurality of captured images obtained by capturing images of an object from a plurality of directions. Specifically, the MBR is a technique for generating a virtual viewpoint image by projecting a plurality of captured images corresponding to an appearance of a three-dimensional shape of a target object obtained by using a three-dimensional shape reconstruction method from a virtual viewpoint as rendering images. For example, a visual hull method or a multi-view-stereo (MVS) method can be used as the three-dimensional shape reconstruction method. The virtual viewpoint image generation method is not limited to these examples. For example, various methods can be used, such as a method of generating a virtual viewpoint image by using projection transform of a captured image without using a three-dimensional model.

The image generation apparatus 120 thus generates a virtual viewpoint image corresponding to each virtual viewpoint transmitted from the plurality of display control apparatuses 130, and transmits the virtual viewpoint image for each virtual viewpoint to the corresponding display control apparatus 130 via a network or the like. The image generation apparatus 120 may be constructed on a cloud service. Even when the image generation apparatus 120 is constructed on a cloud service, the image generation apparatus 120 performs processing of generating a virtual viewpoint image corresponding to each virtual viewpoint transmitted from the plurality of display control apparatuses 130.

The display control apparatus 130 is a smartphone, a personal computer (PC), a tablet terminal, or the like, which are application examples of the information processing apparatus according to the present exemplary embodiment. The display control apparatus 130 includes not only components for performing various information processing, but also an operation unit that receives a user operation, a display unit that displays images, or the like. Examples of the operation unit include a touch panel typically included in a smartphone or a tablet terminal, and a mouse, a keyboard, and a six-axis controller, which are typically included in a PC and the like.

In the present exemplary embodiment, upon receiving an operation of designating a virtual viewpoint from the user, the display control apparatus 130 transmits virtual viewpoint information indicating the virtual viewpoint to the image generation apparatus 120 via a network or the like. In the present exemplary embodiment, the virtual viewpoint information includes at least the position and direction (line-of-sight direction) of the virtual viewpoint. Specifically, the virtual viewpoint information is a set of parameters including a parameter representing a three-dimensional position of a viewpoint, and a parameter representing a direction (line-of-sight direction) of a viewpoint using pan, tilt, and roll directions. The parameter representing a position of a viewpoint is information indicating a three-dimensional position in a virtual space with an origin associated with the position in the imaging area 200, and indicating, for example, a position of a virtual viewpoint relative to a predetermined position such as the center of the imaging area 200. The parameter representing a direction (line-of-sight direction) of a viewpoint is information indicating a direction in which an object is viewed from the viewpoint at the position of the viewpoint. Upon receiving the operation of designating a virtual viewpoint from the user, the display control apparatus 130 transmits virtual viewpoint information including the parameters representing the position and direction of the viewpoint to the image generation apparatus 120 via a network or the like.

Upon receiving the virtual viewpoint information from the display control apparatus 130, the image generation apparatus 120 generates a virtual viewpoint image to be viewed in the line-of-sight direction from the position of the virtual viewpoint included in the virtual viewpoint information. Specifically, the image generation apparatus 120 generates, as a virtual viewpoint image, an image indicating an appearance from the virtual viewpoint when an object is viewed in the direction of the virtual viewpoint from the position of the virtual viewpoint. Further, the image generation apparatus 120 transmits the virtual viewpoint image to the display control apparatus 130. The display control apparatus 130 displays the virtual viewpoint image received from the image generation apparatus 120 on the display unit, thereby making it possible to present the virtual viewpoint image to the user in response to the user operation.

The virtual viewpoint information is not limited to the example of the parameter set described above. For example, a parameter may be used, as the virtual viewpoint information, representing the amount of change in a current frame when the position and direction of the virtual viewpoint in a previous frame are set as a base point. For example, the parameter set used as the virtual viewpoint information may include a parameter representing a size (angle of view) of a vision from a virtual viewpoint. The virtual viewpoint information may include a plurality of parameter sets. For example, the virtual viewpoint information may include a plurality of parameter sets respectively corresponding to a plurality of consecutive frames that form a moving image of virtual viewpoint images, and may be used as information indicating the position and direction of the virtual viewpoint at the respective points of the plurality of consecutive frames.

The display control apparatus 130 may output operation information indicating a content of a user operation and transmit the operation information to the image generation apparatus 120. The image generation apparatus 120 may generate virtual viewpoint information based on the operation information. For example, the function for generating a virtual viewpoint image corresponding to each virtual viewpoint may also be implemented in the display control apparatus 130. In this case, the display control apparatus 130 obtains foreground image data and background image data representing three-dimensional (3D) model information about a content from the image generation apparatus 120, and generates a virtual viewpoint image corresponding to each virtual viewpoint using the obtained foreground image data and background image data. For example, both the image generation apparatus 120 and the display control apparatus 130 may include the function for generating a virtual viewpoint image. One of the image generation apparatus 120 and the display control apparatus 130 to be used to generate a virtual viewpoint image may also be changed depending on a situation. For example, one of the image generation apparatus 120 and the display control apparatus 130 that can generate a higher-quality virtual viewpoint image than the other may be determined and used. Alternatively, one of the image generation apparatus 120 and the display control apparatus 130 that can generate a virtual viewpoint image in a shorter period of time than the other may be determined and used.

### [Hardware Configuration]

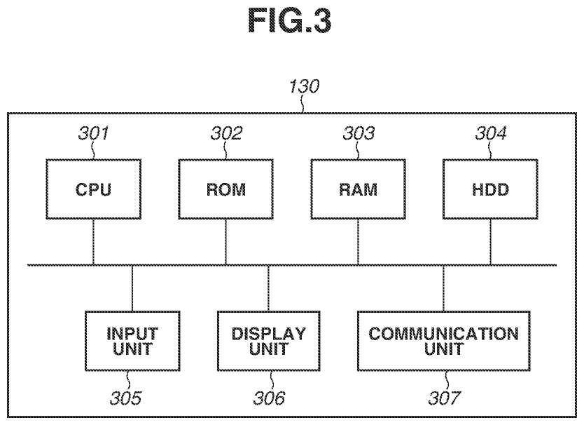

FIG. 3 is a block diagram illustrating a hardware configuration example of the display control apparatus 130 according to the first exemplary embodiment. The hardware configuration of the image generation apparatus 120 is also similar to that of the display control apparatus 130, and thus the illustration and description thereof are omitted. The display control apparatus 130 includes a central processing unit (CPU) 301, a read-only memory (ROM) 302, a random access memory (RAM) 303, a hard disk drive (HDD) 304, an input unit 305, a display unit 306, and a communication unit 307.

The CPU 301 executes various programs including an information processing program according to the present exemplary embodiment stored in the ROM 302 or the HDD 304, thereby implementing various arithmetic processing and functions of the display control apparatus 130 according to the present exemplary embodiment. The display control apparatus 130 may include one or more pieces of dedicated hardware different from the CPU 301. At least some of the processes to be executed by the CPU 301 may be executed by the pieces of dedicated hardware. Examples of the dedicated hardware include an application-specific integrated circuit (ASIC), a field-programmable gate array (FPGA), and a digital signal processor (DSP). The ROM 302 includes a storage area for storing boot programs, control programs, parameters to be set for each unit of the display control apparatus 130, and the like. The RAM 303 is used as a main memory and/or a temporary storage area, such as a work area, for the CPU 301. The HDD 304 stores various data and programs. Another auxiliary storage device such as a solid-state drive (SSD) may be used instead of the HDD 304.

If the display control apparatus 130 is a smartphone, or a tablet terminal, the input unit 305 is composed of, for example, a touch panel. If the display control apparatus 130 is a PC, the input unit 305 is composed of, for example, a keyboard, a mouse, a joystick, a six-axis controller, or a touch panel. The input unit 305 receives an operation from the user and inputs various instructions corresponding to the user operation to the CPU 301. The display unit 306 is composed of, for example, a liquid crystal display or a light-emitting diode (LED), and displays a graphical user interface (GUI) or the like for the user to operate the display control apparatus 130. Accordingly, the CPU 301 also generates a GUI image to be displayed on the display unit 306. The communication unit 307 executes communication processing with an external apparatus such as the image generation apparatus 120. The communication unit 307 may execute communication processing via a wired network such as a LAN, or via a wireless network.

While the present exemplary embodiment illustrates an example where the display unit 306 and the input unit 305 are present in the display control apparatus 130, at least one of the display unit 306 and the input unit 305 may be present as a separate unit on the outside of the display control apparatus 130.

### [Functions and Configuration of Display Control Apparatus]

As described above, the image generation system 100 according to the present exemplary embodiment generates a virtual viewpoint image as an image corresponding to a virtual viewpoint that is, for example, designated by the user. However, as described above, for example, the user may perform the virtual viewpoint operation on favorite scenes, or the user may feel tired and stop the virtual viewpoint operation. In other words, for example, the operation of designating a virtual viewpoint by the user is not performed for a predetermined period of time in some cases.

Accordingly, for example, if the operation of designating a virtual viewpoint by the user is not performed for a predetermined period of time or longer, the display control apparatus 130 according to the present exemplary embodiment sets a virtual viewpoint based on the viewing tendency of the user, and transmits virtual viewpoint information about the set virtual viewpoint to the image generation apparatus 120. As described in detail below, in the first exemplary embodiment, the viewing tendency of the user is obtained based on a history of virtual viewpoints designated by the user before the present time. Accordingly, in this case, the image generation apparatus 120 performs processing of generating a virtual viewpoint image corresponding to a virtual viewpoint set based on the viewing tendency of the user by the display control apparatus 130.

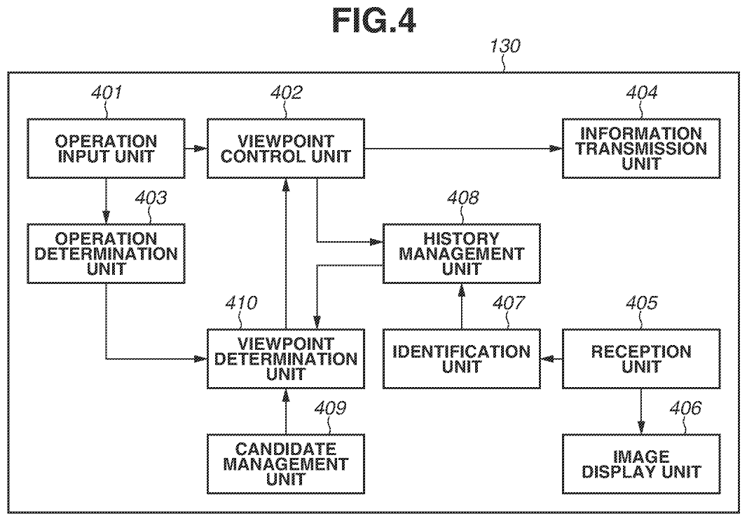

FIG. 4 is a block diagram illustrating a functional configuration example of the display control apparatus 130 according to the present exemplary embodiment. The display control apparatus 130 sets a virtual viewpoint based on the viewing tendency of the user if the operation of designating a virtual viewpoint by the user is not performed for a predetermined period of time or longer, and transmits virtual viewpoint information including the virtual viewpoint to the image generation apparatus 120.

An operation input unit 401 receives a user operation input to the input unit 305 of the display control apparatus 130, identifies the content of the received user operation, and transmits operation information indicating the identified content of the user operation to an operation determination unit 403. If the identified content of the user operation is an operation of designating a virtual viewpoint in a virtual space provided by the content being viewed, the operation input unit 401 transmits operation information indicating the virtual viewpoint to a viewpoint control unit 402. The content of the user operation received by the operation input unit 401 is not limited to this example. The operation input unit 401 can also receive, for example, an instruction to select a content to be viewed, and operations for making various settings on the display control apparatus 130.

The viewpoint control unit 402 calculates virtual viewpoint information indicating the virtual viewpoint in the virtual space, based on information indicating the virtual viewpoint determined based on virtual viewpoint operation information corresponding to the user operation input to the operation input unit 401, or the viewing tendency of the user determined by a viewpoint determination unit 410 to be described below. The viewpoint control unit 402 transmits the calculated virtual viewpoint information to each of an information transmission unit 404 and a history management unit 408.

If a user operation on a virtual viewpoint is not performed for a predetermined period of time, the operation determination unit 403 determines a non-operating state based on the operation information from the operation input unit 401, and notifies the viewpoint determination unit 410 of the non-operating state. The predetermined period of time based on which the non-operating state is determined and the content of the user operation based on which the non-operating state is determined may be preliminarily set, or may be set by the user. The operation determination unit 403 may change the predetermined period of time based on which the non-operating state is determined and the content of the user operation based on which the non-operating state is determined depending on the type of the content to be viewed.

In the present exemplary embodiment, in the case of determining the non-operating state, it may be desirable to also determine whether the state is applicable to exceptions as described below. For example, if a virtual viewpoint for automatically tracking a specific subject is selected, the virtual viewpoint is automatically changed according to a user's intention, so that the user operation is sometimes not performed for a predetermined period of time or longer. As one exception, if a virtual viewpoint for automatically tracking a specific subject is selected, the operation determination unit 403 may be configured not to determine the non-operating state even when the user operation is not performed for a predetermined period of time or longer. Additionally, for example, when the user is continuously viewing a content from the same viewpoint without intentionally changing the virtual viewpoint, the user operation is sometimes not performed for a predetermined period of time or longer. In such a case, the operation determination unit 403 may also be configured not to determine the non-operating state even when the user operation is not performed for a predetermined period of time or longer.

Whether the user is continuously viewing a content from the same viewpoint without intentionally changing the virtual viewpoint can be determined based on, for example, whether the subject is present in the virtual viewpoint image, or the scene of the content being viewed. For example, if the subject is continuously present in the virtual viewpoint image, it is highly likely that the user may be continuously viewing the content from the same viewpoint without changing the virtual viewpoint because the scene of the content being viewed is an interesting scene for the user. In such cases, the operation determination unit 403 may accordingly be configured not to determine the non-operating state even when the user operation is not performed for a predetermined period of time or longer as an exception.

The information transmission unit 404 transmits the virtual viewpoint information transmitted from the viewpoint control unit 402 to the image generation apparatus 120.

A reception unit 405 receives the virtual viewpoint image from the image generation apparatus 120, and transmits the received virtual viewpoint image to each of an image display unit 406 and an identification unit 407.

The image display unit 406 displays the virtual viewpoint image transmitted from the reception unit 405 on the display unit 306 illustrated in FIG. 3.

The identification unit 407 identifies the subject in the virtual viewpoint image transmitted from the reception unit 405, and transmits subject information obtained through subject identification processing to the history management unit 408. Examples of the subject information obtained through the subject identification processing performed by the identification unit 407 include information for identifying each subject, and information indicating the size of each subject in an image, the orientation of each subject, and the like. The subject information is not limited only to these examples. The subject information may also include information for identifying a more detailed state of each subject, such as information indicating the orientation and expression of each subject.

In the case of identifying each subject, the identification unit 407 identifies each subject using, for example, an image recognition technique based on an image or a feature amount of each subject. Alternatively, the identification unit 407 may obtain the position of each subject from the image generation apparatus 120, and may identify each subject in the virtual viewpoint image using the current virtual viewpoint information.

The history management unit 408 associates information about the subject identified by the identification unit 407 from the virtual viewpoint image with the virtual viewpoint information transmitted from the viewpoint control unit 402, and holds the associated information as a virtual viewpoint history. The virtual viewpoint information and the subject information may be associated based on, for example, timecode information indicating time in a content. In other words, for example, the virtual viewpoint information and the subject information that correspond to the same timecode information are associated with each other.

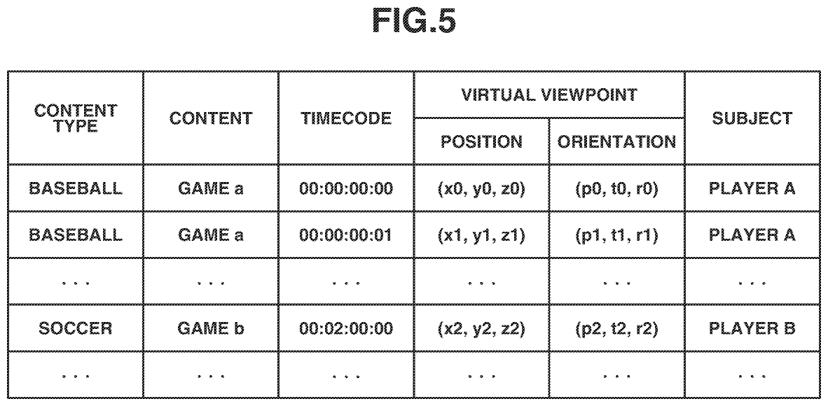

FIG. 5 is a table illustrating an example of the virtual viewpoint history held and managed by the history management unit 408. In the virtual viewpoint history illustrated in FIG. 5, a content type, content information, timecode for identifying each frame, a position and an orientation (direction) of each virtual viewpoint, and information about a subject in an image are associated with each other and are held and managed. If a plurality of players (subjects) is present in an image, pieces of subject information corresponding to the plurality of subjects are held, and some frames may include no subject information. The history management unit 408 that manages, as the virtual viewpoint history, a history of virtual viewpoints from the start of viewing of the content being viewed may also manage a history of virtual viewpoints for each content type (e.g., for each content type, such as a baseball content or a soccer content), including a history of virtual viewpoints for the content previously viewed by the same user.

A candidate management unit 409 manages a plurality of virtual viewpoint candidates. In the present exemplary embodiment, the virtual viewpoint candidates managed by the candidate management unit 409 are, for example, virtual viewpoint candidates that can be designated by the user, for example, by selecting from among the plurality of virtual viewpoints provided by an application or the like used to view the content.

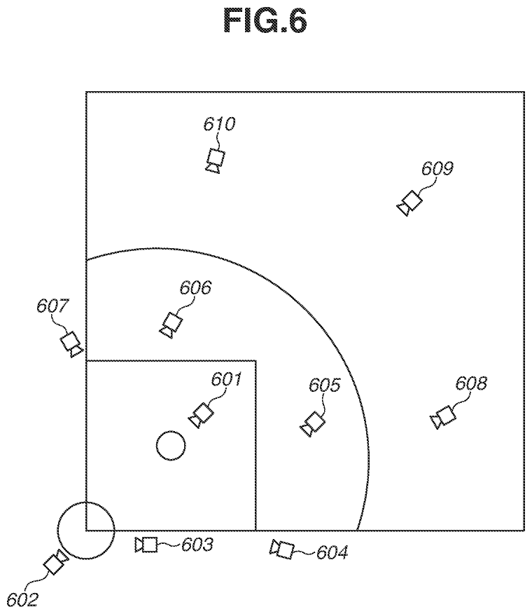

FIG. 6 illustrates an example of a plurality of virtual viewpoint candidates managed by the candidate management unit 409, for example, in a content of watching a baseball game. Virtual viewpoint candidates 601 to 610 illustrated in FIG. 6 are virtual viewpoint candidates that can be selected by the user from among the virtual viewpoints provided by an application or the like used to view the content. In the example illustrated in FIG. 6, the virtual viewpoint candidates 601 to 610 are represented by camera-shaped symbols, respectively, and the user can select a desired virtual viewpoint candidate from among the virtual viewpoint candidates 601 to 610. The virtual viewpoint candidates 601 to 610 are located in a virtual space such that the virtual viewpoint candidates 601 to 610 correspond to the respective players on a baseball field. The virtual viewpoint candidates 601 to 610 each indicate a position suitable for viewing the corresponding player. The position and direction of each of the virtual viewpoint candidates may be fixed, or the position and direction of each of the virtual viewpoint candidates may be changed depending on the actual position and motion of each player. Alternatively, the position of each virtual viewpoint candidate may be fixed and only the line-of-sight direction of each virtual viewpoint may be changed. In addition, a virtual viewpoint for viewing a game from a higher point of view, and a virtual viewpoint for viewing a plurality of players, including a pitcher and a batter, at once may be prepared as virtual viewpoint candidates. Further, user's favorite viewpoints may be registered as virtual viewpoint candidates based on the previous virtual viewpoint history information managed by the history management unit 408. For example, a plurality of points in an area where a virtual viewpoint can be located may be picked up and the plurality of points may be set as virtual viewpoint candidates. For example, a viewpoint for tracking each subject, or a viewpoint for tracking a plurality of subjects may be set as a virtual viewpoint candidate based on subject information included in the content. The virtual viewpoint candidates are not limited to these examples.

Upon receiving a determination notification indicating the non-operating state from the operation determination unit 403, the viewpoint determination unit 410 obtains virtual viewpoint candidates from the candidate management unit 409, and obtains the virtual viewpoint history up to the present time from the history management unit 408. The virtual viewpoint history managed by the history management unit 408 is a history of virtual viewpoints selected by the user before the present time, or a history of virtual viewpoints desired by the user. In other words, the virtual viewpoint history may be information indicating the viewing tendency of the user.

The viewpoint determination unit 410 then selects a virtual viewpoint from among the virtual viewpoint candidates based on the virtual viewpoint history indicating the viewing tendency of the user, and transmits the selected virtual viewpoint information to the viewpoint control unit 402. The virtual viewpoint candidate selection processing that is performed by the viewpoint determination unit 410 based on the virtual viewpoint history will be described in detail below.

### [Operation Flow]

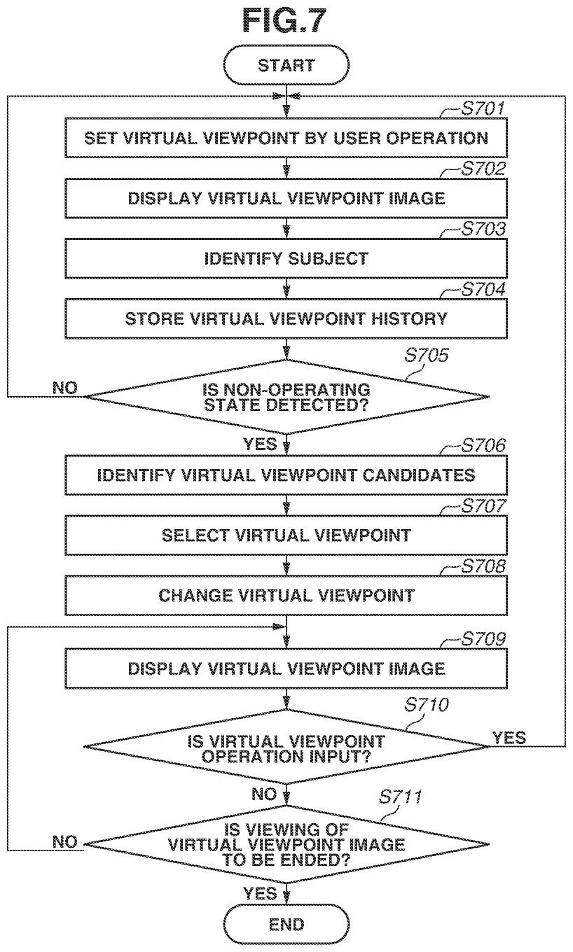

FIG. 7 is a flowchart illustrating a flow of information processing (display control processing) to be performed by the display control apparatus 130 according to the present exemplary embodiment. The processing in the flowchart illustrated in FIG. 7 is implemented by the CPU 301 of the display control apparatus 130 loading the information processing program according to the present exemplary embodiment stored in the ROM 302 or the HDD 304 into the RAM 303 and executing the information processing program. At least some of the processes in the flowchart illustrated in FIG. 7 may be implemented by one or more pieces of dedicated hardware different from the CPU 301.

The processing in the flowchart illustrated in FIG. 7 is started at a timing when the display control apparatus 130 is connected to the image generation apparatus 120 and the user starts viewing a virtual viewpoint image while selecting a content to be viewed and designating a virtual viewpoint. However, the timing of starting the processing in the flowchart illustrated in FIG. 7 is not limited to this timing. Reference symbol “S” in the flowchart illustrated FIG. 7 denotes a process step.

In step S701, upon receiving information about an operation of designating a virtual viewpoint from the user via the operation input unit 401, the viewpoint control unit 402 calculates virtual viewpoint information indicating a virtual viewpoint in a virtual space based on the operation information. The viewpoint control unit 402 transmits the virtual viewpoint information to the image generation apparatus 120 via the information transmission unit 404. Thus, in this case, the image generation apparatus 120 generates a virtual viewpoint image (virtual viewpoint image viewed from the virtual point) corresponding to the virtual viewpoint information transmitted from the information transmission unit 404, and transmits the virtual viewpoint image to the display control apparatus 130.

In step S702, the reception unit 405 corresponds to the virtual viewpoint information calculated in step S701, and receives the virtual viewpoint image that is generated and transmitted by the image generation apparatus 120. This virtual viewpoint image is transmitted to each of the image display unit 406 and the identification unit 407. The image display unit 406 displays the virtual viewpoint image on the display unit 306.

In step S703, the identification unit 407 identifies the subject in the virtual viewpoint image transmitted from the reception unit 405, and transmits subject information obtained by the subject identification processing to the history management unit 408.

In step S704, the history management unit 408 associates the virtual viewpoint information calculated by the viewpoint control unit 402 in step S701 with the subject information obtained in the subject identification processing by the identification unit 407 in step S703, and stores the associated information as a virtual viewpoint history.

In step S705, the operation determination unit 403 determines whether the non-operating state is detected in which the virtual viewpoint operation is not performed by the user for a predetermined period of time or longer. In the case of determining the non-operating state, it may be desirable to also determine whether the state is applicable to the above-described exceptions.

If it is determined that the non-operating state is not detected (NO in step S705), the processing returns to step S701 to repeatedly perform the processing of step S701 and subsequent processing. The display control apparatus 130 thereby displays the virtual viewpoint image in response to the user operation, and updates the virtual viewpoint history.

In contrast, if it is determined that the non-operating state is detected (YES in step S705), the processing proceeds to step S706.

In step S706, the candidate management unit 409 identifies a plurality of virtual viewpoint candidates. As described above in the example illustrated in FIG. 6, if a plurality of virtual viewpoints is provided by an application or the like used to view a content, the candidate management unit 409 identifies virtual viewpoint candidates that can be selected by the user from among the plurality of virtual viewpoints at the time. If virtual viewpoints to be selected by the user are not provided, the candidate management unit 409 identifies virtual viewpoint candidates depending on a content type or the like.

In step S707, the viewpoint determination unit 410 selects a virtual viewpoint from among the virtual viewpoint candidates identified in step S706 based on the virtual viewpoint history that is managed by the history management unit 408 and indicates the viewing tendency of the user up to the time. For example, the viewpoint determination unit 410 selects a virtual viewpoint based on the virtual viewpoint history managed by the history management unit 408. More specifically, the viewpoint determination unit 410 identifies the position of a virtual viewpoint last designated by a user operation before the present time in the virtual viewpoint history managed by the history management unit 408. Further, the viewpoint determination unit 410 selects, as a virtual viewpoint, a virtual viewpoint candidate located at a position closest to the last designated virtual viewpoint from among the plurality of virtual viewpoint candidates identified in step S706. For example, the viewpoint determination unit 410 may identify a movement path of a virtual viewpoint by a user operation from the virtual viewpoint history held in the history management unit 408, may identify a subject of interest of the user based on the movement path of the virtual viewpoint, and may select a virtual viewpoint candidate for viewing the subject of interest as the virtual viewpoint. Specifically, the viewpoint determination unit 410 identifies the virtual viewpoint history for a period from a timecode corresponding to the last designated virtual viewpoint to another timecode indicating time a predetermined period of time before the timecode on the movement path of the virtual viewpoint. The viewpoint determination unit 410 further counts the number of appearances of each subject identified in the image in the identified virtual viewpoint history, and identifies the subject with the largest number of counts as the subject of interest. The viewpoint determination unit 410 then selects a virtual viewpoint candidate for viewing the subject of interest from among the plurality of virtual viewpoint candidates identified in step S706 as the virtual viewpoint.

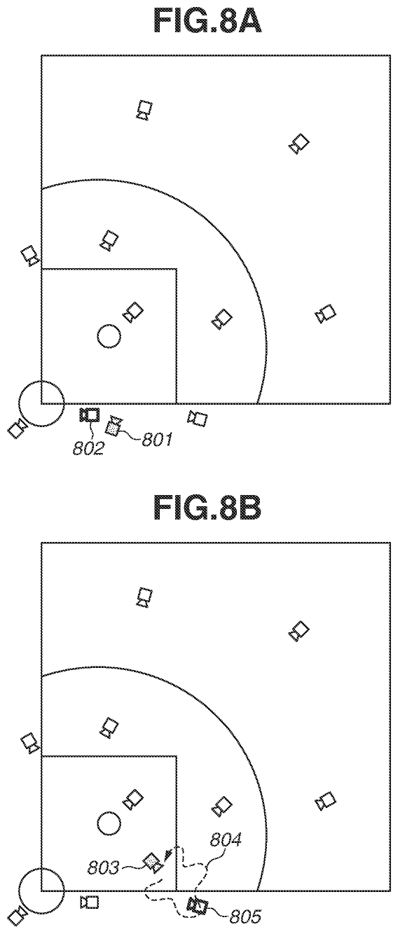

FIGS. 8A and 8B each illustrate an example of the virtual viewpoint selection processing in step S707, in which a virtual viewpoint is selected from among a plurality of virtual viewpoint candidates provided by the application for viewing a baseball game watching content illustrated in FIG. 6.

FIG. 8A illustrates an example of selecting a virtual viewpoint candidate 802 that is located closest to the last designated virtual viewpoint as the virtual viewpoint using positional information about a virtual viewpoint 801 that is last designated by a user operation before the present time in the virtual viewpoint history.

FIG. 8B illustrates an example where a virtual viewpoint path 804 for a virtual viewpoint 803 to move around a first base player while being directed substantially toward the first base player is obtained by a user operation as an example of the virtual viewpoint path identified based on the virtual viewpoint history. FIG. 8B illustrates an example where the subject that is present for the longest period of time in the virtual viewpoint image when the virtual viewpoint 803 moves along the virtual viewpoint path 804 is identified as the subject of interest of the user, and a virtual viewpoint candidate 805 for viewing the subject of interest is selected as the virtual viewpoint. Specifically, if the virtual viewpoint path 804 illustrated in FIG. 8B is identified, the first base player corresponding to the subject that is present for the longest period of time in the virtual viewpoint image is identified as the subject of interest, and the virtual viewpoint candidate 805 for viewing the subject of interest is selected as the virtual viewpoint. Examples of the subject that is present for the longest period of time in the virtual viewpoint image may include the subject with the largest number of counts as the subject identified in the image as described above.

The virtual viewpoint history used to select a virtual viewpoint may be a virtual viewpoint history for only a predetermined period up to the present time in the previous virtual viewpoint history, a virtual viewpoint history for only the current inning in a baseball game watching content, or a virtual viewpoint history for only several innings up to the present time.

Examples of the virtual viewpoint history used to select a virtual viewpoint may include all virtual viewpoint histories for the same content, or all virtual viewpoint histories for the same content type. In addition, the virtual viewpoint history used to select a virtual viewpoint may include only the virtual viewpoint history for a scene of the same content or the same content type, or the virtual viewpoint history for one of an offensive team or a defensive team in a baseball game watching content. The virtual viewpoint history is not limited to these examples.

In addition, if the user selects a virtual viewpoint from among the plurality of virtual viewpoint candidates and views a content from the selected virtual viewpoint, the viewpoint determination unit 410 may select a virtual viewpoint that is selected by the user for the longest period of time, a virtual viewpoint last selected, or a virtual viewpoint selected in the same scene.

The method for selecting a virtual viewpoint based on the virtual viewpoint history is not limited to these examples.

In step S708, the viewpoint control unit 402 transmits virtual viewpoint change information for changing the virtual viewpoint set at the present time to the virtual viewpoint selected in step S707 to the image generation apparatus 120 via the information transmission unit 404. In this case, the image generation apparatus 120 thereby generates the virtual viewpoint image corresponding to the virtual viewpoint changed based on the virtual viewpoint change information transmitted from the information transmission unit 404, and transmits the virtual viewpoint image to the display control apparatus 130.

In step S709, the reception unit 405 receives the virtual viewpoint image that corresponds to the changed virtual viewpoint and is generated and transmitted by the image generation apparatus 120. This virtual viewpoint image is transmitted to each of the image display unit 406 and the identification unit 407. The image display unit 406 displays the virtual viewpoint image on the display unit 306.

In step S710, the operation determination unit 403 determines whether a virtual viewpoint operation is input from the user. If the virtual viewpoint operation is input from the user (YES in step S710), the processing returns to step S701 to repeatedly perform the processing of setting a virtual viewpoint by a user operation and subsequent processing. In contrast, if the virtual viewpoint operation is not input from the user (NO in step S710), the non-operating state is continuously detected and the processing proceeds to step S711.

In step S711, the display control apparatus 130 determines whether viewing of the virtual viewpoint image is to be ended. If it is determined that viewing is not to be ended (NO in step S711), the processing returns to step S709 to repeatedly perform the processing of displaying the virtual viewpoint image in step S709 and subsequent processing. Whether viewing of the virtual viewpoint image is to be ended may be determined based on, for example, an input of a viewing stop instruction from the user, or an end time of the content being viewed. For example, if the viewing stop instruction is input from the user, it is determined that viewing of the virtual viewpoint image is to be ended. For example, if the end time of the content being viewed has been reached, it is determined that viewing of the virtual viewpoint image is to be ended.

When the virtual viewpoint operation is performed by the user after the non-operating state is determined and the virtual viewpoint is changed, the position of a first virtual viewpoint may be set to the position of the virtual viewpoint changed in step S708, or the position of the virtual viewpoint last designated by the user operation in the virtual viewpoint history.

According to the first exemplary embodiment, if the non-operating state in which the virtual viewpoint operation is not performed by the user is detected by the processing described above, the virtual viewpoint selected from among the virtual viewpoint candidates based on the previous virtual viewpoint operation history is used. This makes it possible to obtain the virtual viewpoint image that can be viewed from the virtual viewpoint according to the viewing tendency of the user.

In the present exemplary embodiment, the non-operating state is determined if the virtual viewpoint operation is not performed by the user for a predetermined period of time. Alternatively, if a specific user operation is performed, a virtual viewpoint may be selected based on the viewing tendency of the user, similarly to the case where the non-operating state is determined.

A second exemplary embodiment illustrates an example where if the image generation apparatus 120 is configured to generate a plurality of virtual viewpoint images at once, the display control apparatus 130 identifies virtual viewpoint candidates based on a situation where the image generation apparatus 120 generates virtual viewpoint images, and selects a virtual viewpoint from among the identified virtual viewpoint candidates. The second exemplary embodiment assumes a case where the image generation apparatus 120 is present on a cloud service or the like and is shared by a plurality of users.

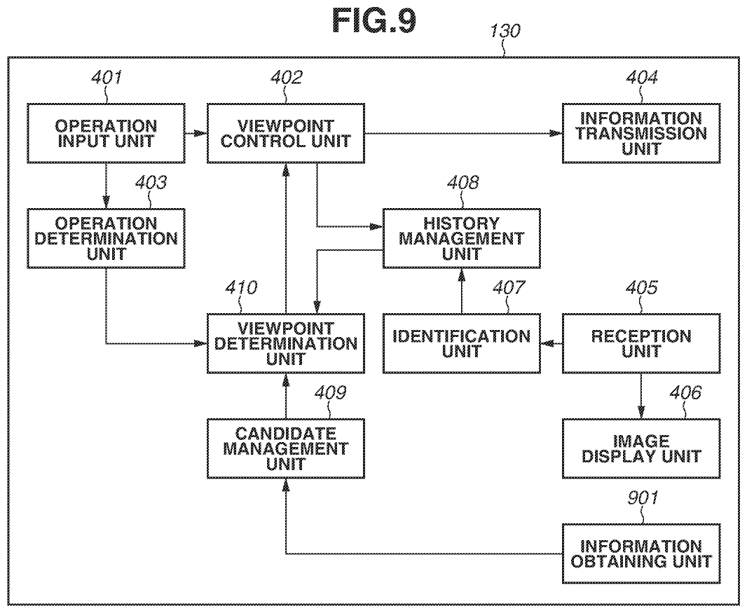

FIG. 9 is a block diagram illustrating a functional configuration example of the display control apparatus 130 according to the second exemplary embodiment. Components in FIG. 9 that perform the same processing as those in the display control apparatus 130 illustrated in FIG. 4 are denoted by the same reference numerals. Only differences between the second exemplary embodiment and the first exemplary embodiment will be described below.

An information obtaining unit 901 obtains image generation information indicating a virtual viewpoint image generated by the image generation apparatus 120 at the present time based on virtual viewpoint information. The image generation information includes virtual viewpoint information used for the image generation apparatus 120 to generate the virtual viewpoint image. Accordingly, if a plurality of virtual viewpoint images is simultaneously generated by the image generation apparatus 120, the information obtaining unit 910 can obtain the virtual viewpoint information used for the plurality of virtual viewpoint images being generated by the image generation apparatus 120 from the image generation information obtained by the image generation apparatus 120. The information obtaining unit 901 transmits the virtual viewpoint information obtained from the image generation information to the candidate management unit 409.

In the second exemplary embodiment, the candidate management unit 409 manages virtual viewpoints indicated by the virtual viewpoint information included in the image generation information obtained by the information obtaining unit 901 as virtual viewpoint candidates.

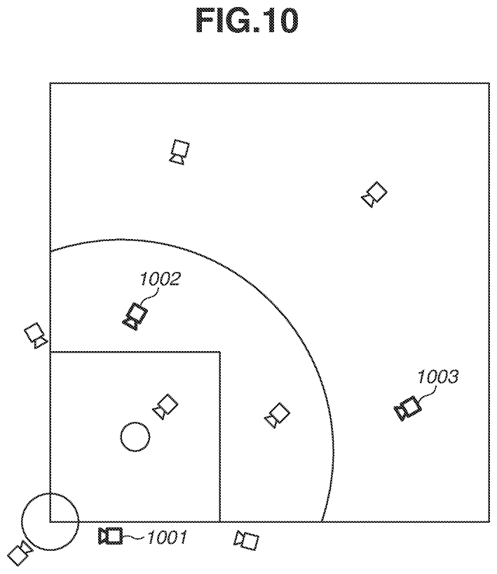

FIG. 10 illustrates an example of virtual viewpoint candidates managed by the candidate management unit 409 according to the second exemplary embodiment. In FIG. 10, virtual viewpoints that are provided by an application or the like used to view a content and can be selected by the user are represented by camera-shaped symbols, like in FIG. 6. FIG. 10 illustrates virtual viewpoints 1001, 1002, and 1003 that are represented by bold camera-shaped symbols as virtual viewpoints corresponding to the plurality of virtual viewpoint images generated by the image generation apparatus 120.

Specifically, in a case where the user is viewing a baseball content in real time, the virtual viewpoints 1001, 1002, and 1003 represent virtual viewpoints selected by another user viewing the baseball content at the same time. The virtual viewpoint images corresponding to the virtual viewpoints 1001, 1002, and 1003 are images currently generated by the image generation apparatus 120. Thus, if any one of the virtual viewpoints 1001 to 1003 is selected by the user or selected by the viewpoint determination unit 410 based on the viewing tendency of the user, there is no need for the image generation apparatus 120 to generate a new virtual viewpoint image. In other words, in this case, the load of image generation processing in the image generation apparatus 120 can be reduced.

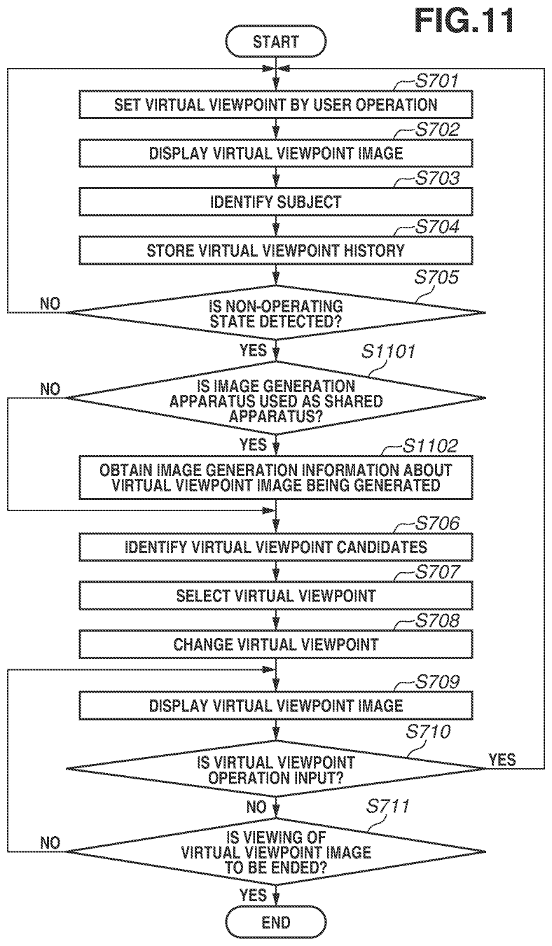

FIG. 11 is a flowchart illustrating a flow of information processing (display control processing) to be performed by the display control apparatus 130 according to the second exemplary embodiment. The flowchart illustrated in FIG. 11 differs from the flowchart illustrated in FIG. 7 described above in that processing of obtaining a virtual viewpoint to be included in virtual viewpoint candidates based on the situation where the image generation apparatus 120 generates virtual viewpoint images is added to the flowchart illustrated in FIG. 7. Processes in FIG. 11 that are identical to the processes in the flowchart illustrated in FIG. 7 are denoted by the same step numbers as those in FIG. 7, and only steps different from the processing of the first exemplary embodiment will be described.

In the second exemplary embodiment, if it is determined that the non-operating state is detected in step S705 (YES in step S705), the processing proceeds to step S1101. In contrast, if it is determined that the non-operating state is not detected in step S705 (NO in step S705), the processing returns to step S701.

In step S1101, the information obtaining unit 901 obtains apparatus information about the image generation apparatus 120 that is generating virtual viewpoint images for the content that is currently being viewed by the user, or information about a connection with another apparatus. The information obtaining unit 901 then determines whether the image generation apparatus 120 is used as a shared apparatus that is also generating a virtual viewpoint image for another user based on the obtained information. If the information obtaining unit 901 determines that the image generation apparatus 120 is not used as the shared apparatus (NO in step S1101), the processing of the display control apparatus 130 proceeds to step S706 described above. In contrast, if the information obtaining unit 901 determines that the image generation apparatus 120 is used as the shared apparatus that is also generating a virtual viewpoint image for another user (YES in step S1101), the processing proceeds to step S1102.

In step S1102, the information obtaining unit 901 obtains image generation information about the virtual viewpoint image being generated from the image generation apparatus 120 and further obtains virtual viewpoint information from the image generation information, and transmits the obtained virtual viewpoint information to the candidate management unit 409. In step S706, the candidate management unit 409 manages virtual viewpoints indicated by the virtual viewpoint information obtained from the image generation information as virtual viewpoint candidates. In other words, the candidate management unit 409 also manages a virtual viewpoint selected by another user as a virtual viewpoint candidate. After the processing of step S1102, the processing of the display control apparatus 130 proceeds to step S706. The processing of step S706 and subsequent processing are similar to those in the flowchart illustrated in FIG. 7 described above, and thus descriptions thereof are omitted.

The above-described processing according to the second exemplary embodiment enables the display control apparatus 130 to set virtual viewpoints corresponding to virtual viewpoint images being generated by the image generation apparatus 120 as virtual viewpoint candidates, if the image generation apparatus 120 that generates virtual viewpoint images is used as the shared apparatus to be shared with another user. Further, the selection of a virtual viewpoint from among these virtual viewpoint candidates makes it possible to view a virtual viewpoint image in consideration of not only the viewing tendency of the user, but also the viewing tendency of another user, and also makes it possible to reduce the load of image generation processing in the image generation apparatus 120.

While the second exemplary embodiment illustrates an example where the virtual viewpoints 1001 to 1003 respectively corresponding to the virtual viewpoint images being generated by the image generation apparatus 120 as illustrated in FIG. 10 are set as virtual viewpoint candidates, the user may arbitrarily set virtual viewpoints.

The image generation information is not limited to image generation information corresponding to virtual viewpoint images created in real time, but instead may be image generation information about generated virtual viewpoint images that are already generated and stored. In other words, if there are virtual viewpoint images that have already been generated in the past, the display control apparatus 130 may obtain image generation information about the previously generated virtual viewpoint images, and may set virtual viewpoints included in the image generation information as virtual viewpoint candidates.

The second exemplary embodiment also illustrates an example where virtual viewpoints corresponding to virtual viewpoint images that are being generated or are already generated by the image generation apparatus 120 are set as virtual viewpoint candidates. However, the present exemplary embodiment is not limited to this example. For example, in the case of providing a service for viewing a virtual viewpoint image by charging money, it is assumed that, for example, whether to charge money may be determined, or different amounts of money may be charged depending on the position or the like of a virtual viewpoint selected by the user. Specifically, it is assumed that different amounts of money are charged for each virtual viewpoint of virtual viewpoint images to be generated by the image generation apparatus 120. In this case, the candidate management unit 409 manages one or more virtual viewpoints used to generate virtual viewpoint images for which different amounts of money are charged as virtual viewpoint candidates. The candidate management unit 409 may set, as virtual viewpoint candidates, virtual viewpoints for which, for example, no money is charged, the charged amount of money is less than or equal to a certain amount of money, or the charged amount of money falls within a specific range desired by the user. On the contrary, the candidate management unit 409 may set, as virtual viewpoint candidates, virtual viewpoints of large amount of charge for which, for example, money is charged, or the charged amount of money is more than or equal to a certain amount of money.

The first and second exemplary embodiments described above illustrate an example where a virtual viewpoint is changed to another virtual viewpoint selected from among virtual viewpoint candidates if the non-operating state in which the user operation on the virtual viewpoint is not performed for a predetermined period of time is detected. A third exemplary embodiment illustrates an example of determining a new virtual viewpoint.

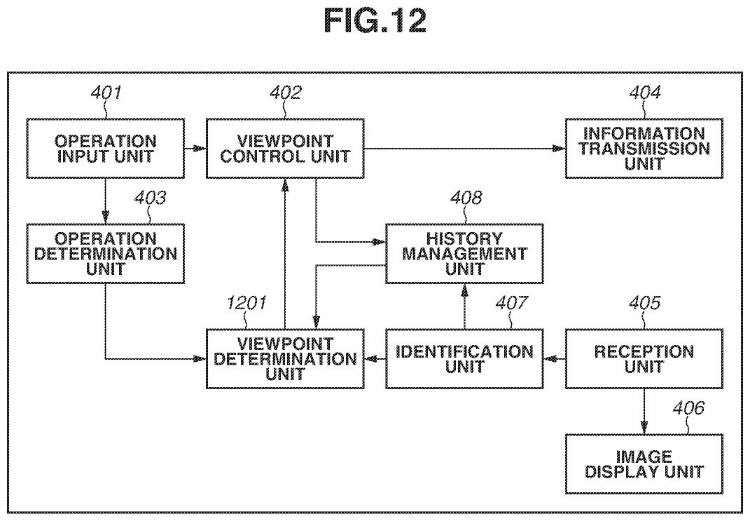

FIG. 12 is a block diagram illustrating a functional configuration example of the display control apparatus 130 according to the third exemplary embodiment. Components in FIG. 12 that perform the same processing as those in the configuration illustrated in FIG. 4 are denoted by the same reference numerals as those in FIG. 4. Only differences between the third exemplary embodiment and the first exemplary embodiment will be described.

Upon receiving a determination notification indicating the non-operating state from the operation determination unit 403, a viewpoint determination unit 1201 obtains the virtual viewpoint history from the history management unit 408 and obtains subject information about the current frame from the identification unit 407. The viewpoint determination unit 1201 then determines the viewing tendency of the user based on the virtual viewpoint history, determines a new virtual viewpoint on the basis of the viewing tendency and the subject information about the current frame, and transmits information about the newly determined virtual viewpoint to the viewpoint control unit 402. In the present exemplary embodiment, the subject information identified by the identification unit 407 may desirably be not only information for identifying the subject in the current virtual viewpoint image, but also information for identifying all subjects, that is, which subject is present at which position in a virtual space. Thus, in the present exemplary embodiment, the identification unit 407 obtains, from the image generation apparatus 120, information about all subjects present in the virtual space including subjects in the current virtual viewpoint image.

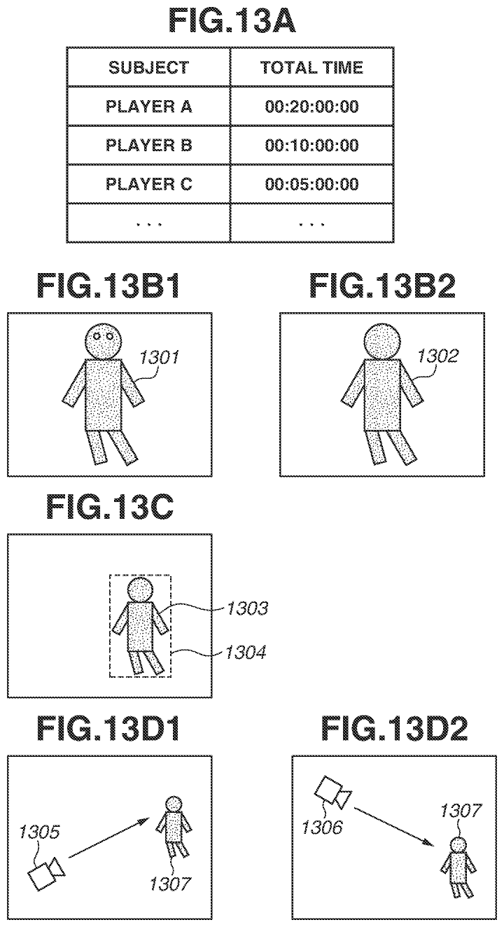

FIGS. 13A to 13D2 each illustrate an example of processing of determining the viewing tendency of the user used for the viewpoint determination unit 1201 to determine a new virtual viewpoint based on the virtual viewpoint history managed by the history management unit 408.

FIG. 13A illustrates information indicating a history of total times during which each subject is present in the virtual viewpoint images. Specifically, the history management unit 408 according to the third exemplary embodiment also manages the history of total times for each subject present in the virtual viewpoint images as exemplified in FIG. 13A. The viewpoint determination unit 1201 determines the subject of interest of the user based on the history of total times for each of the subjects.

For example, it is considered that a subject that is present for a longer total time is more likely to be the subject of interest of the user.

Examples of the subjects on which it is determined whether which one of the subjects captured in virtual viewpoint images corresponds to the subject of interest may include only a subject captured as the whole body of a person in the image, a subject captured as the upper body of a person in the image, or a subject captured as the entire face of a person in the image. For example, a subject with a certain size or larger, or a subject with an area that occupies a certain percent or more of the entire area of the image may also be set as a determination target of the subject of interest. In addition, for example, if a subject is present in the virtual viewpoint image for a predetermined period of time or longer, the subject may also be set as the determination target of the subject of interest. The above-described one or more examples of the determination target may be combined. These are merely examples, and the present exemplary embodiment is not limited only to the above-described examples.

FIGS. 13B1 and 13B2 each illustrate an example of processing of determining the viewing tendency of the user in terms of the direction in which the user views a subject based on the history of orientations of the subject viewed from each virtual viewpoint. FIG. 13B1 illustrates a state where the user views a subject 1301 from the front side. FIG. 13B2 illustrates a state where the user views a subject 1302 from the back side. The direction in which the user views the subject is not limited to these two directions, that is, the front side and the back side of the subject. Four directions, including the left side and the right side of the subject, as well as the front side and the back side of the subject, may be set. More divided directions may also be set. For example, the orientation in which the user views the subject may correspond to the orientation of the upper body of a person, or the orientation of the face of a person, or both of these orientations. The history management unit 408 according to the third exemplary embodiment also manages a history of directions in which the user has viewed the subject. The viewpoint determination unit 1201 also determines a virtual viewpoint for the user to view the subject from a desirable direction based on the history of directions in which the user has viewed the subject. The history of directions is managed by the history management unit 408.

FIG. 13C illustrates an example of processing of determining the viewing tendency of the user in terms of the size of each subject to be viewed based on the history of sizes of the subject in the virtual viewpoint image. The history management unit 408 according to the present exemplary embodiment manages, as the history of sizes of each subject, for example, the size of the subject represented by the number of pixels along an outline of a subject 1303, or the size of a rectangular area 1304 surrounding the subject 1303. The viewpoint determination unit 1201 then determines a virtual viewpoint for the user to view the subject with a desirable size based on the history of sizes of the subject viewed by the user. The history of the size of the subject is managed by the history management unit 408.

FIGS. 13D1 and 13D2 each illustrate an example of processing of determining the viewing tendency of the user in terms of the orientation of each virtual viewpoint based on the history of orientations of each virtual viewpoint. In FIGS. 13D1 and 13D2, virtual viewpoints are also represented by camera-shaped symbols, respectively, as described above. FIG. 13D1 illustrates an example of the orientation of a virtual viewpoint 1305 for looking up at a subject 1307. FIG. 13D2 illustrates an example of the orientation of a virtual viewpoint 1306 for looking down at the subject 1307. The orientation of each virtual viewpoint for the subject is not limited only to these two examples, and more detailed orientations may be used. The history management unit 408 according to the present exemplary embodiment manages the orientation of each virtual viewpoint for viewing the subject as a history. The orientations of each virtual viewpoint for viewing the subject may be managed as, for example, angular information such as an angle of elevation or an angle of depression. The viewpoint determination unit 1201 determines a virtual viewpoint for the user to view the subject with a desired orientation (angle) based on the history of orientations of each virtual viewpoint managed by the history management unit 408.

The history management unit 408 according to the present exemplary embodiment may manage information about the histories as described above in association with a timecode, or may manage the information by counting the number of pieces of information for each history item. The information held in the history management unit 408 is not limited to information about the histories and the like as described above, but instead the information may be set or changed by the user.

In the present exemplary embodiment, the viewpoint determination unit 1201 determines the viewing tendency of the user using the virtual viewpoint history stored in the history management unit 408, and determines a virtual viewpoint based on the viewing tendency. However, the virtual viewpoint determination method is not limited to this example. For example, the viewpoint determination unit 1201 may determine a virtual viewpoint based on the viewing tendency of the user by using an artificial intelligence.

In the third exemplary embodiment, the size and orientation of each subject and the orientation of each virtual viewpoint may also be finely adjusted based on the virtual viewpoint history on the basis of the virtual viewpoint selected from among virtual viewpoint candidates described above in the first and second exemplary embodiments. Alternatively, only the orientation or the angle of view of each virtual viewpoint may be changed while the position of the virtual viewpoint last designated by the user is fixed. A virtual viewpoint path that is continuous in a temporal direction may be held as the virtual viewpoint history, and a motion of each virtual viewpoint may be determined based on the virtual viewpoint history.

According to third exemplary embodiment, the above-described processing makes it possible to implement the processing of, for example, determining a new virtual viewpoint and changing the virtual viewpoint according to the viewing tendency of the user based on the previous virtual viewpoint history, if the non-operating state in which the virtual viewpoint operation is not performed by the user for a predetermined period of time is detected.

The present disclosure can also be implemented by the following processing. That is, a program for implementing one or more functions according to the exemplary embodiments described above is supplied to a system or an apparatus via a network or a storage medium, and one or more processors in a computer of the system or the apparatus read out and execute the program. The present disclosure can also be implemented by a circuit (e.g., an ASIC) for implementing one or more functions according to the exemplary embodiments described above. The above-described exemplary embodiments are merely embodied examples for carrying out the present disclosure. The technical scope of the present disclosure should not be interpreted in a limited way by the above-described exemplary embodiments. That is, the present disclosure can be carried out in various ways without departing from the technical idea and the main features thereof. According to the present disclosure, it is possible to provide an appropriate virtual viewpoint image to a user even when a virtual viewpoint operation is not performed by the user.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Applications No. 2023-018628, filed Feb. 9, 2023, and No. 2023-186821, filed Oct. 31, 2023, which are hereby incorporated by reference herein in their entirety.

What is claimed is:

1. An information processing apparatus comprising:
a history management unit configured to manage a virtual viewpoint designated by a user operation as a virtual viewpoint history;
a viewpoint determination unit configured to determine a virtual viewpoint based on the virtual viewpoint history managed by the history management unit; and
a viewpoint control unit configured to set the virtual viewpoint determined by the viewpoint determination unit as a virtual viewpoint used to generate a virtual viewpoint image.

2. The information processing apparatus according to claim 1, further comprising a determination unit configured to determine a non-operating state in which a user operation for designating the virtual viewpoint is not performed for a predetermined period of time,
wherein, in a case where the determination unit determines the non-operating state, the viewpoint determination unit determines the virtual viewpoint based on the virtual viewpoint history held in the history management unit prior to the determination of the non-operating state.

3. The information processing apparatus according to claim 1, wherein in a case where a specific user operation is performed, the viewpoint determination unit determines the virtual viewpoint based on the virtual viewpoint history managed by the history management unit.

4. The information processing apparatus according to claim 1, further comprising an identification unit configured to identify a subject from the virtual viewpoint image generated based on the set virtual viewpoint, the virtual viewpoint designated by the user operation being set as the virtual viewpoint used to generate the virtual viewpoint image,
wherein the history management unit associates information about the subject identified by the identification unit with the virtual viewpoint designated by the user operation, and includes the information in the virtual viewpoint history to manage the information.

5. The information processing apparatus according to claim 1, further comprising a candidate management unit configured to manage one or more virtual viewpoint candidates,
wherein the viewpoint determination unit selects a virtual viewpoint candidate from among the virtual viewpoint candidates managed by the candidate management unit based on the virtual viewpoint history managed by the history management unit, and determines the selected virtual viewpoint candidate as the virtual viewpoint.

6. The information processing apparatus according to claim 5, wherein the candidate management unit manages, as the virtual viewpoint candidates, virtual viewpoints selectable by a user from among a plurality of virtual viewpoints.

7. The information processing apparatus according to claim 5, wherein the candidate management unit manages, as the virtual viewpoint candidates, a plurality of virtual viewpoints provided depending on a type of a content viewed by a user.

8. The information processing apparatus according to claim 5, wherein the viewpoint determination unit identifies a position of the virtual viewpoint designated by the user operation based on the virtual viewpoint history managed by the history management unit, selects a virtual viewpoint candidate from among the virtual viewpoint candidates based on the identified position of the virtual viewpoint, and determines the selected virtual viewpoint candidate as the virtual viewpoint.

9. The information processing apparatus according to claim 8, wherein the viewpoint determination unit identifies a position of a virtual viewpoint last designated by the user operation based on the virtual viewpoint history managed by the history management unit, selects a virtual viewpoint candidate located at a position closest to the identified position of the virtual viewpoint from among the virtual viewpoint candidates, and determines the selected virtual viewpoint candidate as the virtual viewpoint.

10. The information processing apparatus according to claim 5, wherein the viewpoint determination unit identifies a movement path of the virtual viewpoint designated by the user operation based on the virtual viewpoint history managed by the history management unit, selects a virtual viewpoint candidate from among the virtual viewpoint candidates based on the identified movement path of the virtual viewpoint, and determines the selected virtual viewpoint candidate as the virtual viewpoint.

11. The information processing apparatus according to claim 10, wherein the viewpoint determination unit identifies a subject of interest of a user based on the identified movement path of the virtual viewpoint, selects a virtual viewpoint candidate for the subject of interest from among the virtual viewpoint candidates, and determines the selected virtual viewpoint candidate as the virtual viewpoint.

12. The information processing apparatus according to claim 1, further comprising:
a transmission unit configured to transmit information about the virtual viewpoint set by the viewpoint control unit to an image generation apparatus based on a plurality of images captured for each of a plurality of viewpoints, the image generation apparatus being configured to generate a virtual viewpoint image corresponding to a virtual viewpoint;
a reception unit configured to receive the virtual viewpoint image generated by the image generation apparatus based on the virtual viewpoint set by the viewpoint control unit; and
a display unit configured to display the received virtual viewpoint image.

13. The information processing apparatus according to claim 12, further comprising:
an obtaining unit configured to obtain virtual viewpoints used to generate a virtual viewpoint image that is being generated or is already generated by the image generation apparatus; and
a candidate management unit configured to manage the virtual viewpoints obtained by the obtaining unit as virtual viewpoint candidates,
wherein the viewpoint determination unit selects a virtual viewpoint candidate from among the virtual viewpoint candidates managed by the candidate management unit based on the virtual viewpoint history managed by the history management unit, and determines the selected virtual viewpoint candidate as the virtual viewpoint.

14. The information processing apparatus according to claim 12, further comprising a candidate management unit configured to manage, as virtual viewpoint candidates, one or more virtual viewpoints used to generate a virtual viewpoint image for which different amounts of money are charged in a case where the different amounts of money are charged for each of the virtual viewpoints to generate the virtual viewpoint image by the image generation apparatus,
wherein the candidate management unit sets virtual viewpoint candidates selected from among the managed virtual viewpoint candidates based on the charged amounts of money as virtual viewpoint candidates used for the viewpoint determination unit to determine the virtual viewpoint.

15. The information processing apparatus according to claim 14, wherein the candidate management unit sets virtual viewpoint candidates for which no money is charged, a predetermined amount of money or less is charged, or the charged amount of money falls within a specific range, as virtual viewpoint candidates used for the viewpoint determination unit to determine the virtual viewpoint.

16. The information processing apparatus according to claim 1, wherein the viewpoint determination unit determines a viewing tendency of a user based on the virtual viewpoint history managed by the history management unit, and determines the virtual viewpoint based on the viewing tendency of the user.

17. The information processing apparatus according to claim 16,
wherein the history management unit further manages, for each subject, a history of total times during which the subject is present in the virtual viewpoint image, and
wherein the viewpoint determination unit determines the viewing tendency of the user based on the history of total times for each subject managed by the history management unit.

18. The information processing apparatus according to claim 16,
wherein the history management unit further manages, for each subject, a history of orientations of the subject viewed from the virtual viewpoint, and
wherein the viewpoint determination unit determines the viewing tendency of the user based on the history of orientations of the subject managed by the history management unit.

19. An information processing method comprising:
managing a virtual viewpoint designated by a user operation as a virtual viewpoint history;
determining a virtual viewpoint based on the managed virtual viewpoint history; and
setting the determined virtual viewpoint as a virtual viewpoint used to generate a virtual viewpoint image.

20. A non-transitory computer readable storage medium storing a program for causing a computer to execute an information processing method, the method comprising:
managing a virtual viewpoint designated by a user operation as a virtual viewpoint history;
determining a virtual viewpoint based on the managed virtual viewpoint history; and
setting the determined virtual viewpoint as a virtual viewpoint used to generate a virtual viewpoint image.
